(19) United States
(12) Patent Application Publication
(10) Pub. No.: US 2008/0181576 A1
(43) Pub. Date: Jul. 31, 2008

(54) ADDITIONAL SUBTITLE PROVIDING METHOD AND ADDITIONAL SUBTITLE REPRODUCING APPARATUS

(75) Inventors: Man-seok Kang, Suwon-si (KR); Sung-wook Park, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/832,757

(22) Filed: Aug. 2, 2007

(30) Foreign Application Priority Data
Jan. 25, 2007 (KR) 2007-7908

(51) Int. Cl. H04N 5/91

(52) U.S. Cl. 386/95

(57) ABSTRACT

A method of providing an additional subtitle to reproduce an externally input subtitle and AV data and an additional subtitle reproducing apparatus. The method includes linking information on at least one external subtitle data and reproduction control information of audio video (AV) data and adding the linked information to navigation information of the AV data; and reproducing the AV data and one of at least one internal subtitle data of the AV data or one of the at least one external subtitle data based on the navigation information.

### CROSS-REFERENCE TO RELATED APPLICATIONS

This application claims the benefit of Korean Application No. 2007-7908, filed in the Korean Intellectual Property Office on Jan. 25, 2007, the disclosure of which is incorporated herein by reference.

### BACKGROUND OF THE INVENTION

1. Field of the Invention

Aspects of the present invention relate to subtitles of audio visual (AV) data, and more particularly, to an additional subtitle providing method for reproducing an externally input subtitle and AV data, and an additional subtitle reproducing apparatus.

2. Description of the Related Art

FIG. 1 is a block diagram of a conventional reproducing apparatus 100. The conventional reproducing apparatus 100 is used to reproduce a Bluray disc 110. The reproducing apparatus 100 comprises a reading unit 120 for reading AV streams recorded in the Bluray disc 110 and a reproducing unit for reproducing the AV streams. The reproducing unit comprises a DEMUXER 130 and decoders 140 through 180. The DEMUXER 130 divides the AV streams into a video stream, an audio stream, a bitmap subtitle stream or a text subtitle stream, and an interactive graphic stream. Once the AV streams are divided, the DEMUXER 130 transfers the streams to a video decoder 140, an audio decoder 150, a presentation graphic decoder 160 or a text subtitle decoder 170, and an interactive graphic decoder 180, respectively. Data decoded by each of the decoders 140 through 180 is mixed and output to a display 190 and a speaker 191.

FIG. 2 is a diagram showing the structure of conventional AV data. An AV stream comprises a plurality of clips 222 making up recording units. Characteristics information of compressed AV data must be known in order to reproduce the clips 222. Thus, each clip 222 has clip information 221. The clip information 221 includes an entry point map on which location information of entry points is recorded and AV properties of a corresponding clip. A random access can be performed at entry points having a regular period. A playlist 211, which is a basic reproduction unit, comprises consecutive playitems 212 through 214 and includes navigation information to determine a connection reproduction and reproduction sequence of clip files and to control reproduction of the AV data. Playitems 212 through 214 correspond to parts of a clip 222. In particular, the playitems 212 through 214 designate reproduction start and end times, and acquire their locations in the clip 222 based on the clip information 221.

FIG. 3 is a diagram showing the structure of conventional playlist information. The playlist information includes stream information 212 of a playitem 0 and stream information 213 of a playitem 1. Video stream information 311, audio stream information 312, presentation graphic information 313, and interactive graphic information 314 are recorded in playitem 0. Video stream information 321, audio stream information 322, presentation graphic information 323, and interactive graphic information 324 are recorded in playitem 1.

When a subtitle is reproduced, the reproducing apparatus 100 selects a packet identifier code (PID) of a packet including subtitle data from packets that are multiplexed in the AV streams, using the presentation graphic information 313 and 323 included in the playlist that is to be reproduced, and informs the DEMUXER 130 of the PID. Data having the PID is transmitted to the presentation graphic decoder 160 or the text subtitle decoder 170, decoded, and output to the display 190. When the AV streams include a plurality of subtitle data, a user selects one of the subtitles included in the presentation graphic information 313 such as playitem 0 212, through an interface such as an on display screen (OSD) menu, and reproduces the subtitle.

However, conventionally a subtitle must be included in AV streams and presentation graphic information. A system that supports an additional subtitle stored in an external storage medium cannot change from a subtitle being reproduced to the external additional subtitle. If the system stops reproducing AV streams and an internal subtitle and changes the internal subtitle to the external subtitle, the system needs to reproduce the AV streams from the beginning, making it impossible to control reproduction.

### SUMMARY OF THE INVENTION

Aspects of the present invention provide an additional subtitle providing method that reproduces additional external subtitle data in the same manner that subtitle data included in original audio video (AV) streams is reproduced and that changes the two subtitles being reproduced, and an additional subtitle reproducing apparatus.

According to an aspect of the present invention, a method of providing an additional subtitle is provided. The method comprises linking information on at least one external subtitle data and reproduction control information of audio video (AV) data; adding the linked information to navigation information of the AV data; and reproducing the AV data and one of at least one internal subtitle data of the AV data or one of the at least one external subtitle data based on the navigation information.

According to another aspect of the present invention, the adding of the linked information to navigation information of the AV data comprises adding reproduction control information on the at least one external subtitle data to stream information of a playitem included in playlist information of the AV data.

According to another aspect of the present invention, the adding of the linked information to navigation information of the AV data further comprises adding, to the navigation information, information on a path on which the at least one external subtitle data is recorded and/or information indicating that the at least one external subtitle data is an external subtitle.

According to another aspect of the present invention, the method further comprises receiving a path on which the at least one external subtitle data is recorded; outputting a list of the external subtitle data recorded on the path; and reading information on the at least one external subtitle data selected from the list of the external subtitle data.

According to another aspect of the present invention, the reproducing of the AV data may comprise: if a subtitle conversion command is input, reproducing the AV data from a part where the reproduction of the AV data has been stopped in order to input the subtitle conversion command, with the internal subtitle data or the external subtitle data indicated by the subtitle conversion command.

According to another aspect of the present invention, an apparatus to reproduce AV data and subtitle data is provided. The apparatus comprises an external storage medium reading unit to read external subtitle data from an external storage medium; an external subtitle adding unit to link information on the external subtitle data and reproduction control information of the AV data and to add the linked information to navigation information of the AV data; and a reproducing unit to reproduce, based on the navigation information, the AV data and one internal subtitle data of the AV data or the external subtitle data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional reproducing apparatus;

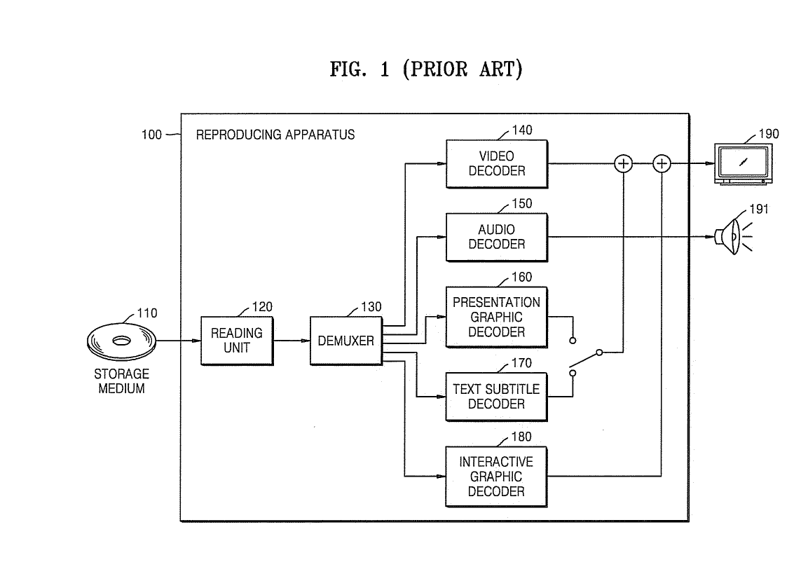

FIG. 2 is a diagram showing the structure of conventional audio video (AV) data;

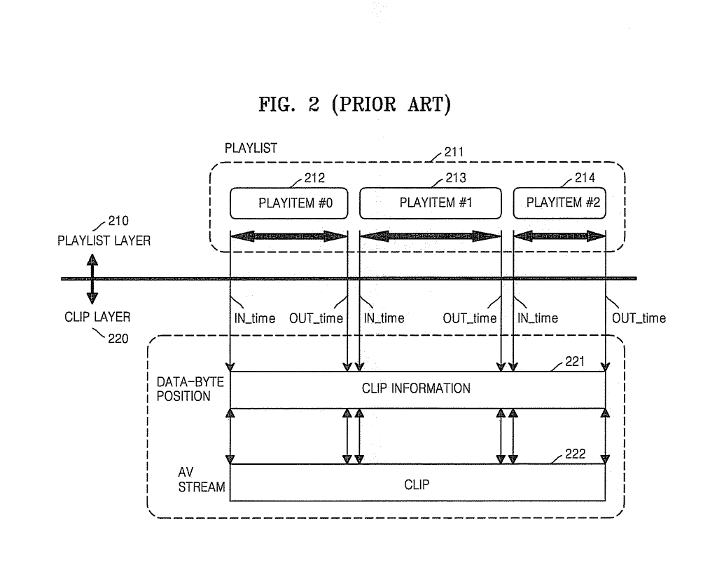

FIG. 3 is a diagram showing the structure of conventional playlist information;

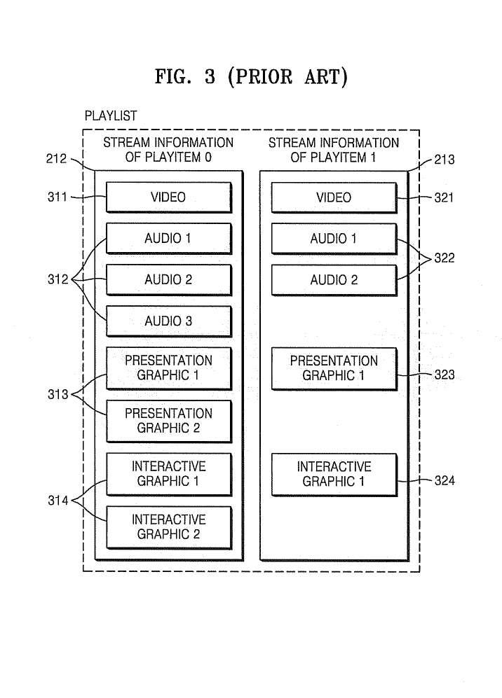

FIG. 4 is a block diagram of a reproducing apparatus according to an embodiment of the present invention;

FIG. 5 is a block diagram of a reproducing apparatus according to another embodiment of the present invention;

FIG. 6 is a diagram showing the structures of initial playlist information and two pieces of external subtitle information to be added according to an embodiment of the present invention;

FIG. 7 is a diagram showing the structure of playlist information to which two pieces of external subtitle information are added according to an embodiment of the present invention; and

FIG. 8 is a flowchart illustrating an additional subtitle providing method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

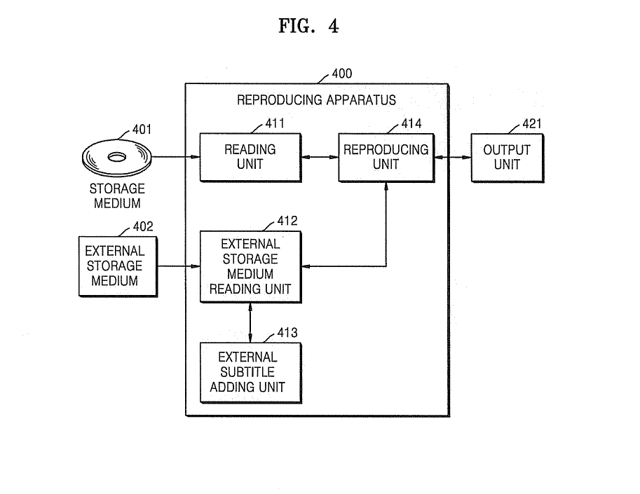

FIG. 4 is a block diagram of a reproducing apparatus 400 according to an embodiment of the present invention. The reproducing apparatus 400 comprises a reading unit 411 that reads audio video (AV) data from a storage medium 401 such as a Bluray disc (BD) or a digital versatile disc (DVD), a reproducing unit 414 that reproduces the AV data and outputs the AV data to an output unit 421, an external storage medium reading unit 412 that reads external subtitle data having information about at least one external subtitle from an external storage medium 402, and an external subtitle adding unit 413 that adds the at least one external subtitle to an internal subtitle recorded in the storage medium 401. According to other aspects of the invention, the reproducing apparatus 400 may include additional components; similarly, the functionality of two or more of the above units may be combined into a single component.

The external subtitle adding unit 413 links information on the at least one piece of external subtitle data and reproducing control information of the AV data and adds the linked information to navigation information of the AV data. The external subtitle adding unit need not be directly connected to the recording apparatus 400 but may be connected to the recording apparatus 400 through a network such as a local area network (LAN) or the Internet. The navigation information determines a connection reproduction and reproduction sequence of clip files and controls reproduction of the AV data. The navigation information to which the linked information is added is buffered or stored in a memory.

Since the linked information is added to the navigation information, although the at least one external subtitle is added to the internal subtitle, it is not necessary to reproduce a reproduction unit from the beginning and it is possible to continue reproducing the reproduction unit. The reproducing unit 414 reproduces the internal subtitle or the external subtitle and the AV data based on the navigation information to which the linked information is added. The reproducing apparatus 400 provides a user with a list of available internal and external subtitles based on the navigation information and reproduces AV streams with a subtitle selected by the user. If the user changes the subtitle into another subtitle, the reproducing apparatus 400 resumes reproducing the AV streams from a current reproduction position and outputs the new subtitle.

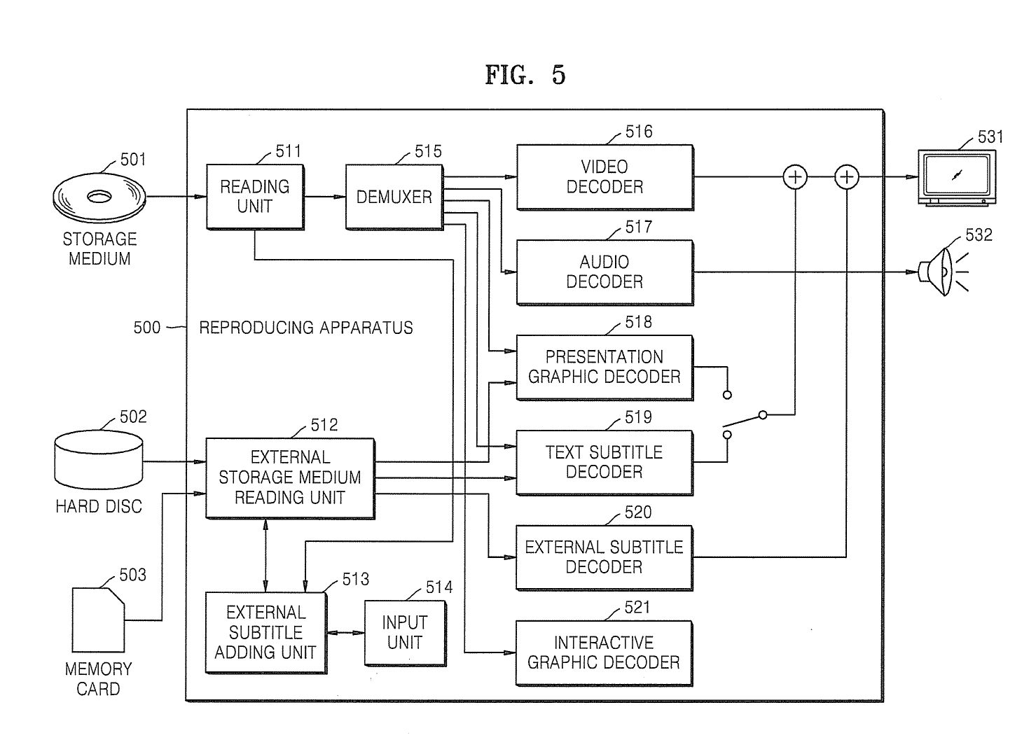

FIG. 5 is a block diagram of a reproducing apparatus 500 according to another embodiment of the present invention. The reproducing apparatus 500 is a BD reproducing apparatus. The reproducing apparatus 500 comprises a reading unit 511 that reads AV data from an internal storage medium 501; and a reproducing unit that reproduces the AV data through a DEMUXER 515 and decoders 516 through 521, and that outputs the AV data through a display 531 and a speaker 532. The decoders 516 through 521 decode different stream types. The reproducing apparatus 500 further comprises an external storage medium reading unit 512, an external subtitle adding unit 513, and an input unit 514. The internal storage medium 501 may be a removable optical information storage medium, such as a BD.

The external storage medium reading unit 512 reads external subtitle data from external storage media such as a hard disc 502, a universal serial bus (USB) storage medium (not shown), a memory card 503, etc. The external subtitle adding unit 513 adds information on the external subtitle data to original navigation information. The input unit 514 inputs a user's subtitle selection and/or a storage path of the external subtitle data. The external storage media are not limited to, but can include, a remote storage medium accessible via a network. As shown in FIG. 5, the reproducing apparatus 500 includes a network interface, but the reproducing apparatus 500 according to other aspects of the invention may not have a network interface, or may communicate with an external storage medium in another way.

The external subtitle adding unit 513 outputs to the display 531 a list of the external subtitle data stored in a predetermined path or a path selected by the user, reads information on the external subtitle data selected by the user through the external storage medium reading unit 512, processes the information on the external subtitle data so as to have a format similar or identical to that of information on the internal subtitle data, and adds the processed information on the external subtitle data to the navigation information such as playlist information for controlling reproduction of the AV data.

The external subtitle decoder 520 decodes subtitle data having a different format from the subtitle data format included in the internal storage medium 501. For example, if external subtitle decoders are added to the reproducing apparatus 500, the user can freely add subtitle data having a different format from a text subtitle format or presentation graphics of a BD-ROM. The external subtitle decoders recognize subtitle data having various formats, such as a storage management initiative (SMI) format used on a PC.

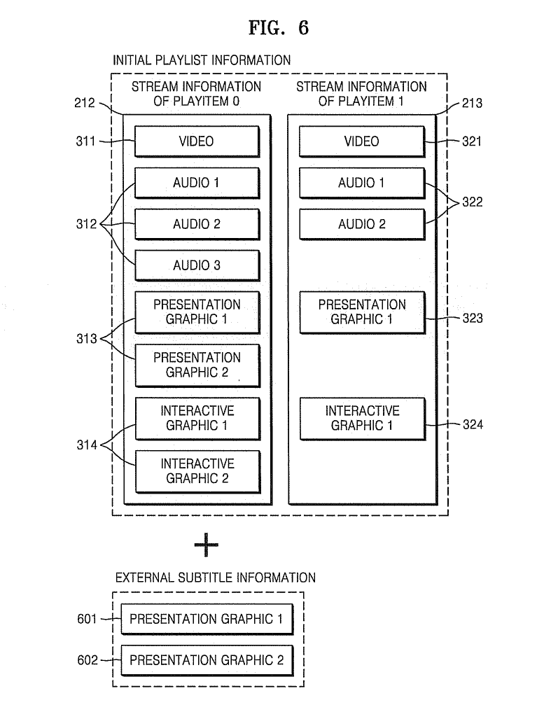

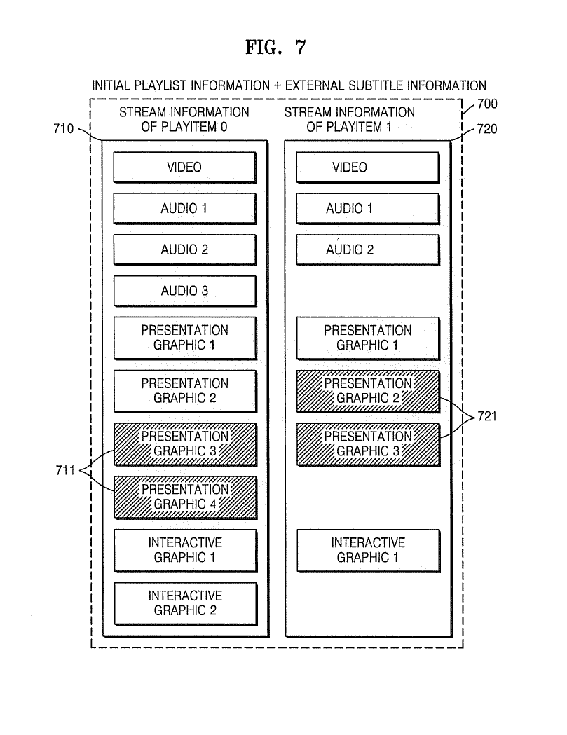

FIG. 6 is a diagram showing the structures of initial playlist information and external subtitle information 601, 602 to be added according to an embodiment of the present invention. FIG. 7 is a diagram showing the structure of playlist information 700 to which external subtitle information is added according to an embodiment of the present invention. Referring to FIG. 7, the external subtitle information 601 and 602 illustrated in FIG. 6 are added to each playitem of the initial playlist information.

External subtitle information 711 and 721 are added to stream information 710 and 720, respectively, of each playitem included in the initial playlist information that is included in a title being reproduced. The external subtitle information 711 and 721 include reproduction control information for synchronizing the external subtitle data with the AV streams stored in the storage medium, reproducing the external subtitle data, and changing the external subtitle data into another subtitle data. The two pieces of external subtitle information 711 and 721 can further include a storage path of the external subtitle data referred to when reproducing an external subtitle or a flag identifying the external subtitle or an internal subtitle. If flag information is displayed on a reproducible subtitle list, the user can easily identify an additional subtitle.

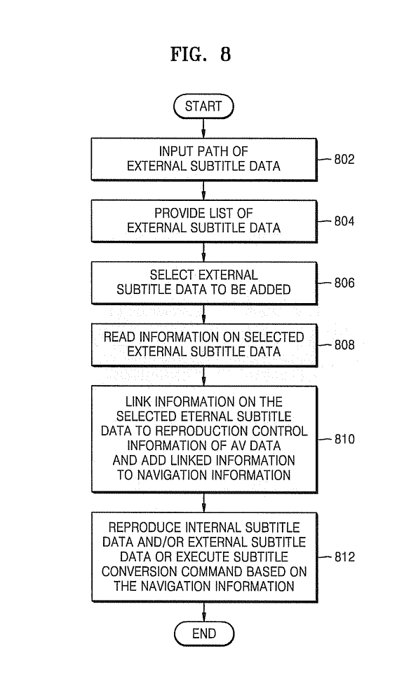

FIG. 8 is a flowchart illustrating a technique of providing an additional subtitle according to an embodiment of the present invention. Although the technique shown in FIG. 8 is described with reference to the reproducing apparatus 500, any apparatus may employ the technique shown in FIG. 8. Additional subtitle data is recorded on the external storage medium 502. The external storage medium 502 is connected to the reproducing apparatus 500 so as to be accessible by the reproducing apparatus 500. After a user selects a title that is to be reproduced or while the title is being reproduced, the user executes a menu of the reproducing apparatus 500 to select an external subtitle and designates a path of the external storage medium 502 on which the additional subtitle data is recorded. If the path on which the additional subtitle data is recorded is input (operation 802), the reproducing apparatus 500 generates a list of the reproducible external subtitle data using data read from the path and provides the user with the list (operation 804). If the user partially or wholly selects the external subtitle data from the list (operation 806), information on the selected external subtitle data is read from the external storage medium (operation 808).

The external subtitle information is processed in the form of reproduction control information of the AV data, linked to the reproduction control information of the AV data, and added to navigation information (operation 810). For example, information on each piece of subtitle data selected by the user is added to presentation graphic information of a playitem included in a playlist of a title that is to be reproduced as one piece of presentation graphic data. A flag to discriminate subtitle information added by the user and subtitle information included in the storage medium, and information on a file path on which subtitle data added by the user is recorded, can be stored in the navigation information.

The navigation information is used to selectively reproduce one of internal subtitle data and external subtitle data desired by the user, or to execute a subtitle conversion command while reproducing the title (operation 812). After resuming reproduction of the title, the user can reproduce subtitles added by the user other than subtitles provided by the internal storage medium 501, and freely change the subtitles. If the subtitle conversion command is input, the title is reproduced with the internal subtitle data or the external subtitle data indicated by the subtitle conversion command. If the title reproduction is temporarily stopped, the title reproduction resumes from a part where the reproduction stops to input the subtitle conversion command.

External subtitle provision techniques according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CDs and DVDs; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). The computer readable recording medium can also be distributed over network coupled computer systems so that the computer readable code is stored and executed in a distributed fashion. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to aspects of the present invention, a subtitle can be added from an external storage medium other than a storage medium on which AV data is recorded, and an internal subtitle and the additional subtitle can be changed in the same manner that internal subtitles are changed.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of providing an additional subtitle for AV data reproduced by a reproducing apparatus, the method comprising:
linking information on external subtitle data and reproduction control information of audio video (AV) data;
adding the linked information to navigation information of the AV data; and
reproducing the AV data and internal subtitle data of the AV data or the external subtitle data based on the navigation information.

2. The method of claim 1, wherein the adding of the linked information to navigation information of the AV data comprises:
adding reproduction control information on the at least one external subtitle data to stream information of a playitem included in playlist information of the AV data.

3. The method of claim 1, wherein the adding of the linked information to navigation information of the AV data further comprises:
adding, to the navigation information, information on a path on which the external subtitle data is recorded and/or information indicating that the external subtitle data is an external subtitle.

4. The method of claim 1, further comprising:
receiving a path on which the external subtitle data is recorded;
outputting a list of the external subtitle data recorded on the path; and
reading information on the external subtitle data selected from the list of the external subtitle data.

5. The method of claim 1, wherein, if a subtitle conversion command is input, the reproducing of the AV data comprises:
reproducing the AV data from a part where the reproduction of the AV data has been stopped in order to input the subtitle conversion command, With the internal subtitle data or the external subtitle data indicated by the subtitle conversion command.

6. An apparatus to reproduce AV data and subtitle data, the apparatus comprising:
an external storage medium reading unit to read external subtitle data from an external storage medium;
an external subtitle adding unit to link information on the external subtitle data and reproduction control information of the AV data and to add the linked information to navigation information of the AV data; and
a reproducing unit to reproduce, based on the navigation information, the AV data and one of at least one internal subtitle data of the AV data or the external subtitle data.

7. The apparatus of claim 6, wherein the external subtitle adding unit adds reproduction control information on the external subtitle data to stream information of a playitem included in playlist information of the AV data.

8. The apparatus of claim 6, wherein the external subtitle adding unit adds, to the navigation information, information on a path on which the external subtitle data is recorded and/or information indicating that the external subtitle data is an external subtitle.

9. The apparatus of claim 6, further comprising:
an input unit to receive a path on which the external subtitle data is recorded;
wherein the external subtitle adding unit outputs a list of the external subtitle data recorded on the path, and reads information on the external subtitle data selected from the list of the external subtitle data.

10. The apparatus of claim 6, wherein, if a subtitle conversion command is input, the reproducing unit reproduces the AV data from a part where the reproduction of the AV data has been stopped in order to input the subtitle conversion command, with the internal subtitle data or the external subtitle data indicated by the subtitle conversion command.

11. The apparatus of claim 6, wherein the reproducing unit comprises:
a demuxer to split the AV data into a plurality of streams;
a plurality of decoders to decode the plurality of streams, wherein each decoder decodes one of the plurality of streams;
an external subtitle decoder to decode the external subtitle data received from the external subtitle adding unit;
a mixing unit to mix the decoded plurality of streams and to reproduce the mixed stream.

12. The apparatus of claim 11, wherein the external subtitle decoder decodes external subtitle data having a format different from the internal subtitle data.

13. A method of seamlessly changing between an internal subtitle and an external subtitle during reproduction of video, the method comprising:
linking external subtitle information received from an external storage medium to reproduction control information of AV data received from an internal storage medium;
adding the linked external subtitle information to navigation information;
reproducing the AV data;
receiving a command to switch to an external subtitle during reproduction of the AV data; and
displaying external subtitle data indicated by the command and corresponding to the external subtitle information using the linked external subtitle information.

14. An apparatus to reproduce AV data and subtitle data and to seamlessly change between internal subtitles and external subtitles, the apparatus comprising:
a reading unit to read AV data and internal subtitle data from an internal storage medium;
an external subtitle reading unit to read external subtitle data and external subtitle information about the external subtitle data from an external storage medium;
an external subtitle adding unit to add the external subtitle information to playlist information in the AV data, the playlist information including information on AV data to be reproduced; and
a reproducing unit to reproduce the AV data and the external subtitle data or the internal subtitle data and to switch between displaying an internal subtitle included in the internal subtitle data and an external subtitle included in the external subtitle data based upon a command received from a user.

15. The apparatus of claim 14, wherein the internal storage medium is a removable optical information storage medium.

16. The apparatus of claim 14, wherein the external storage medium is connected to the reproducing apparatus via a network.

17. The apparatus of claim 14, wherein:
the external subtitle data has a format different from the internal subtitle data; and
the reproducing unit comprises an external subtitle decoding unit to decode the external subtitle data.

18. The apparatus of claim 14, wherein the external subtitle information comprises:
reproduction control information to synchronize the external subtitles with the AV data, to reproduce the external subtitles, and to change the external subtitles into another subtitle format.

19. The apparatus of claim 18, wherein the external subtitle information further comprises:
storage path information identifying a storage path of the external subtitles; and
flag information indicating that the external subtitle is an external subtitle.

20. The apparatus of claim 14, wherein the reproducing unit switches between the internal subtitle and the external subtitle in the same manner as switching between two internal subtitles.
